(19) United States
(12) Patent Application Publication
(10) Pub. No.: US 2017/0087814 A1
(43) Pub. Date: Mar. 30, 2017

(54) Process of Making Laminate Structures with High Barrier Extrusion Coating for Flexible Packaging

(71) Applicant: KAMAKSHI FLEXIPRINTS PVT.LTD., Ahmedabad,Gujarat (IN)

(72) Inventor: Harish Goel, Ahmedabad, Gujarat (IN)

(73) Assignee: Kamakshi Flexiprints Pvt. Ltd., Ahmedabad, Gujarat (IN)

(21) Appl. No.: 15/112,191

(22) PCT Filed: Dec. 1, 2014
(86) PCT No.: PCT/IN2014/000745

§ 371 Date: Jul. 17, 2016

(30) Foreign Application Priority Data
Jan. 17, 2014 (IN) 164/MUM/2014

(51) Int. Cl. B32B 37/15; B32B 7/12; B32B 27/32; B32B 37/02; B32B 37/16

(52) U.S. Cl. CPC B32B 37/153; B32B 37/02; B32B 37/16; B32B 27/32; B32B 7/12; B32B 2439/70; B32B 2553/00

(57) ABSTRACT

A method and system of producing barrier laminate structure (12) for flexible packaging by co-extrusion coating/lamination of one or more substrates (16, 26), using one or more extrusion coating/lamination stations, comprising of one or more extruders (18, 30) at each of the stations, operating in isolation or in tandem yielding multilayered extrusion coating/lamination (ECL1, ECL2), comprises one or more intermediate barrier layer(s) and/or adhesive/tie/sealant layer(s) (20, 32) in the final laminate for enhanced oxygen, gas and moisture barrier as also aroma retention.

### FIELD OF THE INVENTION

The present invention relates to the flexible packaging system specifically to laminated structures used for improved barrier properties obtained from the sublayers of multilayer extrusion coating/lamination.

### BACKGROUND OF THE INVENTION

It is known that barrier properties of the packaging will determine its ability to withstand the impact of oxygen, water vapor gases and other environmental stresses, on the contents of the package and the impact of the product packed on the pack.

Further, laminated structures made up of different and varying compositions provide corresponding strength, appeal, barrier and other properties required in the final packaging, based on the type of the product and its content to be packed.

EP0951390 discloses multilayered packaging material for flexible packaging comprising metallization layer which requires specific arrangement of lamination system and is costly.

US application US20110076506 discloses producing a multi-layer barrier film by producing a blown film of n-layers, by a blown extrusion process and subsequently collapsing the n-layer blown film to form 2n multi-layer barrier film and laminating this film to the inside of the substrate by an adhesive layer in extrusion lamination process.

In this n layered multilayer blown barrier film (MLBF), layer of LDPE and POP are used as support layers to barrier polymers, to address low melt strength of barrier polymers without any significant contribution to the barrier properties of the film produced on a separate multilayered extrusion blown film line which is not necessary in the proposed process With improved property of the Tie layers, the barrier layers are included as sub layers in the extrusion coating/lamination process.

Also in this application it is shown adhesive layer are fed separately to laminate then layered multilayer barrier blown film and substrate on an extrusion lamination line in another process.

Conventionally, work has been done in the area of laminated structures, such as, in some conventional systems and methods, laminate structures are made through extrusion coating lamination process Further, in the conventional systems, the production of the blown film with barrier properties can be carried in a separate production line such that the barrier polymers are away from the lamination machine. The blown film is then laminated with substrate through extrusion coating lamination or using adhesives by solution process However, in the conventional laminated structures/systems and the process of making the same, there are limitations of the product which can be stored in the packaging; liquids based on the choice of substrate i.e. paperboard and the blown film process for making the laminate structures if the blown film is not a barrier film. The conventional lamination systems and methods have limitations like using SBS paper board or thicker blown film laminates, meant for containers in the context of liquid food packaging like juices & milk products.

Still further, some prior arts teach about EVOH that is a barrier layer that can be applied by dispersion, solution and also extrusion coating but these prior arts fail to teach both well-defined extrusion coating/lamination and an acceptable layer combination of nylon and EVOH to form a barrier layer.

Thus, a need is felt for making laminate structures with high barrier properties without depending on the metallic layer and/or multilayered blown extrusion barrier film.

### OBJECT OF INVENTION

Primary object of the present invention is to provide laminated structures comprising of multiple layers/films laminated together with multilayer extrusion coating/lamination layers wherein the multilayer extrusion coating/lamination contains n sublayers of barrier polymers.

Another object of the present invention is to reduce number of layers in a given barrier laminate structure and still provide high barrier facility to protect contents of packed material.

Another object of the present invention is to provide multilayer extrusion laminated structures with better barrier properties comprising wherein laminate providing high barrier properties is obtained from the intermediate layers of multilayered extrusion coating/lamination irrespective of the properties of the substrates.

Another object of the present invention is to improve the efficiency of the laminate structure due to the versatility available due to the capability of the layers available in the lamination process to laminate different substrates to yield a number to attributes in terms of aesthetics, barrier, sealability etc. contributed by the respective primary or secondary substrates and the choice of the sublayers of extrusion coating/lamination.

Still another object of the present invention is to provide cost effective process for preparation of different laminate structures on a machine having two or more extrusion coating/lamination stations in one production line without use of adhesive by gravure process

Still another object of the present invention is to provide a process for preparation of laminate by way of extrusion coating/lamination using either single or more combinations of polymer and offering barrier properties therefrom.

### SUMMARY OF THE INVENTION

The present invention relates to providing laminated structures comprising of multiple layers/films laminated together with multilayer extrusion coating/lamination polymer layers with barrier properties wherein high barrier properties in the laminate is obtained from the intermediate sublayers of multilayered extrusion coating/lamination irrespective of the properties of the substrates which are coated/laminated during extrusion coating/lamination.

The laminated structures can be provided at two or more extrusion coating/lamination stations on a line, operating either in tandem or stand alone, wherein each extrusion station comprises of two or more extruders to process different polymers in, either single or any one or more combinations of polymer selected from but not limited to Nylon, EVOH, PVOH, PVDC, EAA, EMAA, Ionomers, PETG, PC, PE, PP, Grafted polyolefins or TiO2 or other such polymer or blends thereof, yielding Extrusion coating/lamination, of one or more intermediate barrier layer and/or functioning as adhesive/barrier/seal/tie/release layer in the final laminate.

Novelty of the present invention is reducing number of layer in the given laminate structure and still provide high barrier facility to protect contents of packed material. This is the main difference between the present invention and existing systems.

In the present invention extruded barrier film and adhesive layer come from the same station. At this station barrier film/layer sandwiched by two adhesive layers (Tie layer) where, barrier film/layer may be a single layer or multilayered.

This above extrusion lamination molten film is further sandwiched by two substrates, primary substrate and secondary substrate or layered on to the primary substrate to form an adhesive/barrier/tie/seal/release coating layer in the final laminate.

Better barrier properties need to be provided against gas, moisture and oxygen to protect the contents inside the package that is produced after the lamination/coating process Further, the contents packed in the package could comprise of solids, semi solids or even liquids for enhanced shelf life of the product thereby reducing the inventory which needs to be maintained by the manufacturer in various forms as also being able to provide consumers with longer lasting and fresher products such as processed food, potato wafers, ketchup, edible oils, petroleum oils, industrial chemicals and oils, meat, various gels in lamitubes, condoms, alcohols, fresh fruits & vegetables, medical products, pharma etc. in any type of packs like centre sealed pouches, three side sealed pouches, doy packs, with or without spouts, whether or not Nitrogen flushed or vacuum packed or any other type of flexible packaging.

This will not only benefit the consumers but also reduce the cost for manufacturing by reducing storage cost (refrigeration cost) of the product and most importantly improve the supply chain for fresh produce whereby it is estimated that approximately 30% of farm produce in India such as fruits, vegetables, grains etc. either gets spoilt or lost due to pilferage and leads to high food inflation and a great loss to the exchequer.

### DETAILED DESCRIPTION OF THE INVENTION

Laminated structures comprising of multiple layers/films laminated together with multilayer extrusion coating/lamination polymer layers with better barrier properties obtained from the intermediate sublayers of multilayered extrusion coating lamination irrespective of the properties of the substrates which is laminated during extrusion coating/lamination.

The laminated structures can be provided at one or more extrusion coating stations on a line, operating either in tandem or stand alone, wherein each extrusion station comprises of two or more extruders to process different polymers in, either single or any one or more combinations of polymer selected from but not limited to Nylon, EVOH, PVOH, EAA, EMAA, Ionomers, PETG, PC, PE, PP, Grafted polyolefins or TiO2 or other such polymer or blends thereof, yielding ECL, of one or more intermediate barrier layer and/or functioning as adhesive/barrier/seal/tie/release layer in the final laminate. Extruder barrier layer and/or adhesive layer come from the same or different station and sandwiched by two adhesive layers/Tie layer where, barrier layer film may be a single layer or multilayer.

The extrusion lamination film is further sandwiched by two substrates which primary substrate and secondary substrate where primary substrate is coming from supply prior to station and the secondary substrate is coming from supply next to station. As these all extrusion lamination and both substrates are gathered at one station making the system very much cost effective and fast working. Also the same system can be extended with multiple such stations if required.

Substrate can be but not limited to a surface or reverse printed or unprinted, coated or uncoated mono or coextruded, cast or blown film of Pet/PP/PE/PA/EVOH/PS/PVC/PLA or blends thereof mono or bi-axially oriented matt or gloss, opaque or transparent whether or not metallized or paper or foil or laminate thereof by way of extrusion coating or solution based adhesive applied by gravure process or mayer bar or transfer roll mechanism or any other such process.

Primary substrate and secondary substrate are any type of film whether or not metallized or Pearlised, matt or gloss, transparent or opaque or any other PET, PP, Nylon, PE cellophane, pvc, film comprising of one or more layers, cast or blown, mono or biaxially oriented film, aluminum foil, paper or laminate structure of any one or combinations and/or explained substrate to form a laminate roll by Extrusion Lamination or Adhesive lamination by gravure process or mayer bar or transfer roll mechanism or any other such process.

In the present invention relating to laminate structure comprises of primary substrate, multilayer extrusion barrier film/layer and secondary substrate, In which multilayer extrusion barrier film/layer is sandwiched between primary substrate and secondary substrate with extrusion coating lamination wherein high barrier properties in the laminate is obtained from the intermediate sublayers of multilayered extrusion coating/lamination irrespective of the properties of the primary substrate or secondary substrate which is laminated during extrusion coating/lamination process.

Here in the present invention high barrier property terminology is related to the material proportion used for making of barrier film which may be single layer or multilayer in the extrusion coating/lamination process, further details are covered in example section of this invention.

There are mainly two type of substrate used in the present invention:
Primary substrate
Secondary substrate

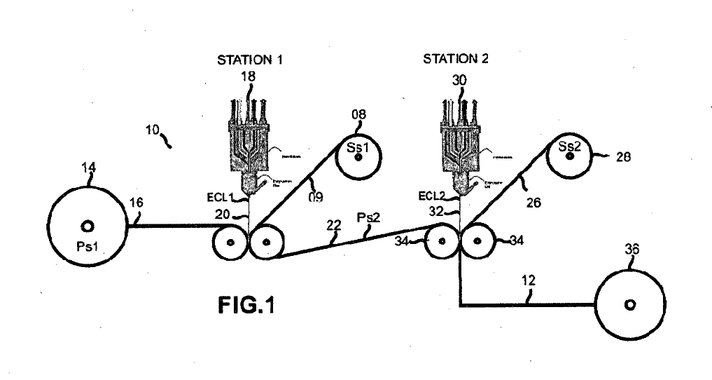

Primary substrate is a substrate fed from the unwinder 14 in FIG. 1 at station 1 on the extrusion coating/lamination 18 in FIG. 1 and the secondary substrate is coming from unwinder 8 and these both substrates and extrusion lamination layer are gathered at station 1, to get stuck forming the composite of substrate-extrusion lamination-substrate, as shown in FIG. 1. If further attributes of properties like seal, barrier, release, aesthetics etc. is required then thus formed film can be progressed to the next station for further extrusion coating/lamination having barrier/seal/release layer sandwiched or outside of by tie layers as per the requirement of the application of the laminated structure. Here this film become primary substrate for the next station and secondary substrate comes from the unwinder 28 on station 2 and primary substrates are denoted by Ps1,Ps2,Ps3,Ps4 . . . etc. and secondary substrates are denote by Ss1,Ss2,Ss3,Ss4 . . . etc. which can be easily understood from FIG. 1.

The extrusion coating/lamination layer is made of one or more combinations of Nylon, EVOH, PVOH, EAA, EMAA, Ionomers, PETG, PC, PE, PP, Grafted polyolefins or TiO2 or Tie Resins etc. to yield one or more sub layers of each material in extrusion coating/lamination layer or other polymer on a line for laminating/coating primary and secondary substrates: blown or cast monoaxially oriented or biaxially oriented, printed or unprinted, matt or gloss, coated or uncoated or laminates thereof.

The present invention actually addresses packaging applications using not only paper but various other substrates and/or laminated/coated rolls consisting of a combination of such substrates. The extrusion coating layer is having barrier properties and can be used as coating layer and/or adhesion layer for laminating two substrates. The packaging material can be made using primary substrates such as PET, BON, PP Films, PE Films, Aluminum Foil, Paper, Nylon or a laminate/coated structure made of any combination of these substrates. The laminate roll of above two substrates produced at first station of ECL line with or without barrier properties in the ECL layer, shall then, if required, can be further laminated, through extrusion coating with or without barrier properties, with a secondary substrate such as PET, BON, PP Films, PE Films, Aluminum Foil, Nylon. Paper or a laminate structure made of combination of these substrates. In any case one or both of the extrusion coating/laminating layer would be with barrier properties.

A preferred example of sublayers of extrusion layer in lamination wherein, there are five sublayers comprises, from the outside to inside:
a tie layer
first polymer layer
gas barrier layer
second polymer layer
a tie layer

A preferred example of sublayers of extrusion layer in coating wherein, there are five sublayers comprises, from the outside to inside:
a tie layer
first polymer layer
gas barrier layer
second polymer layer
a sealant layer

This layer offers the barrier and is layered onto inside or outside of any of the substrates.

Wherein the gas barrier layer as mentioned above may comprise of ethylene vinyl alcohol (EVOH), polyglycol alcohol (PGA), PVOH, PVDC etc.

FIG. 1 is production line 10 for manufacturing of laminate/coated structure. In this invention presently using two station for extrusion coating/lamination in production line, but in future for further implementing n number of station can be used for process making it more efficient and increasing the production which may acts as laminating or coating or both. There are two station in this present invention which act as a lamination/coating or both at respective station at the production line in which generally called station-1 and station-2. Station-1 contains n nos of extruders capable of processing respective polymers to feed into feed block to combine n sublayers to form a single layer of these n sublayers and also capable to merge, split or redistribute the order of the n sublayers fed from the extruders 18 through the distribution block inside the feed block that can be changed to reconfigure order of n sublayers and station-2 contain n nos of extruders capable of processing respective polymers to feed into feed block to combine n sublayers to form a single layer of these n sublayers and also capable to merge, split or redistribute the order of the n sublayers fed from the extruders 30 through the distribution block inside the feed block that can be changed to reconfigure order of n sublayers.

Here both station-1 and station-2 are used as either lamination station or coating station, feed block at extruders 18 provide either a barrier layer with adhesive layer or nothing, while feed block at extruders 30 must provide a multilayer barrier film of n sublayers with or without adhesive layer. Hence station 1 act as a either lamination station or coating station with or without barrier but in this case the second station must be lamination station or coating station with barrier if station 1 is not with barrier. A roll 14 provide primary substrate 1 (Ps-1) 16 and roll 8 provide secondary substrate 1 (Ss1) 9 in FIG. 1. For lamination process, layer 20 act as a barrier film with adhesive layer.

For coating process on Station 1, the layer 20 from feed block at extruders 18 is layered on a substrate which is either on unwinder 14, or unwinder 8 depending on the side on which coating is required. The coating can be with or without barrier and/or adhesive layer.

Output of station-1 is substrate 22 which is either laminated or coated.

Now for lamination process at Station 2, substrate 22 is input for station-2, hence it used as a primary substrate 2 (Ps2), a secondary substrate (Ss2) 26 come from roll 28 in FIG. 1. Feed block at extruders 30 provide barrier film 32 in FIG. 1 with adhesive and so extrusion coating/lamination takes place at station 2. Station 2 provides a barrier film 32 with or without adhesive layer.

For Coating at Station 2, substrate 22 is layered with layer 32 from Feed block at extruder 30. The coating can be with or without barrier and/or adhesive layer.

Outcome of station 2 is 12 in FIG. 1. 12 may either be a final packaging material or can act as primary substrate for repetition of whole process. Outcome 12 is wound on role 36 in FIG. 1.

The production line 10 thus can be used as following or in a combination thereof.

FIG. 1—Station 1 and Station 2 both used for lamination

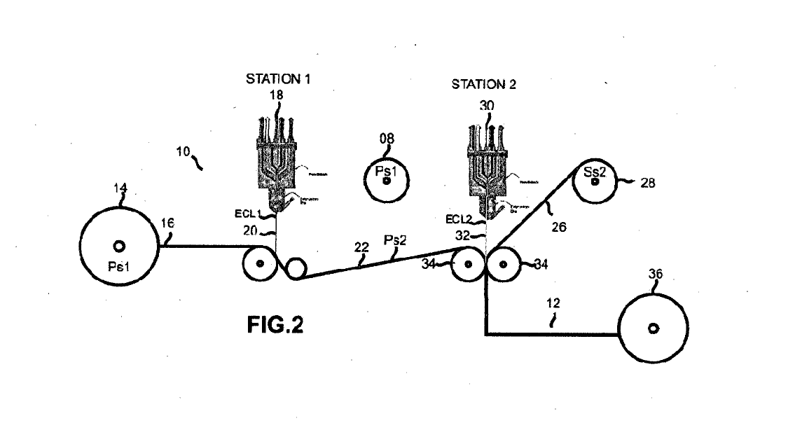

FIG. 2—Station 1 used for coating and station 2 used for lamination

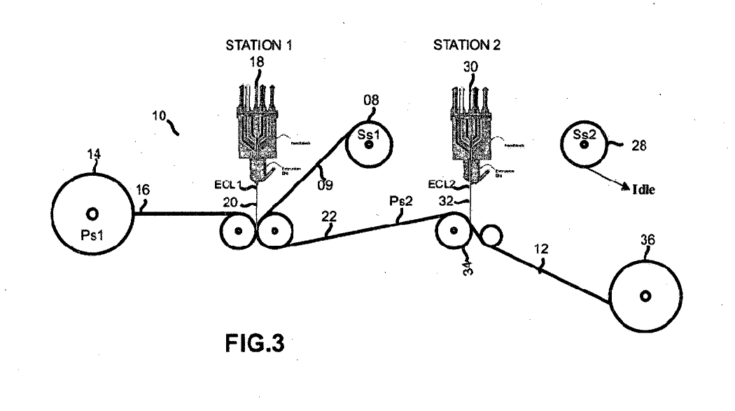

FIG. 3—Station 1 used for Lamination and station 2 used for coating

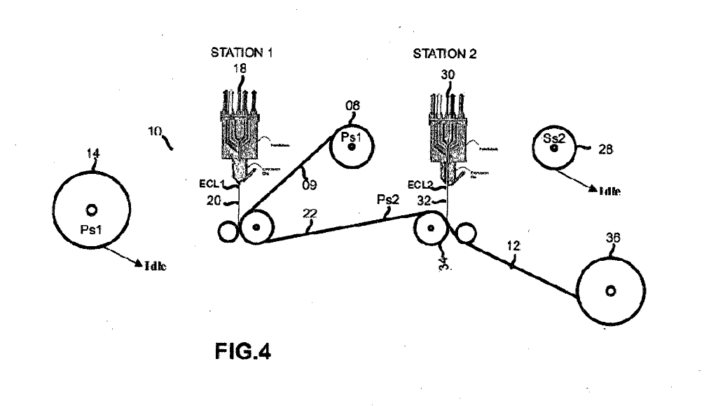

FIG. 4—Station 1 used for Coating and station 2 also used for coating

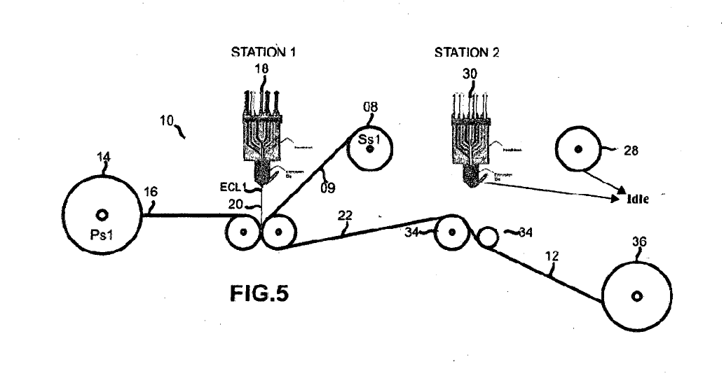

FIG. 5—Any one of Station 1 or station 2 used for lamination and the other Station is kept in off condition.

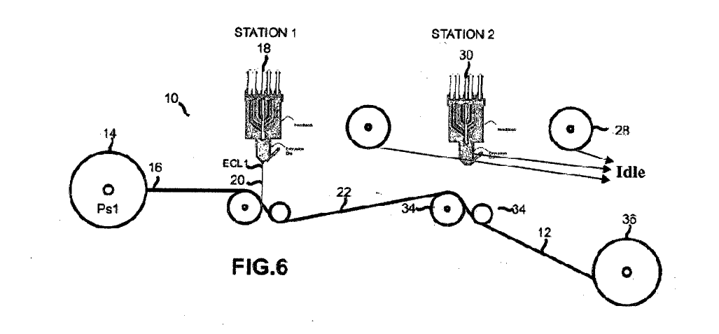

FIG. 6—Any one of Station 1 or station 2 used for coating and the other Station is kept in off condition.

A further elaboration of the above combination is described as under:

FIG. 1—A roll 14 provides primary substrate 1 (Ps-1) 16 and roll 8 provide secondary substrate 1 (Ss1) 9. Lamination process layer 20 comprising of n sublayers act as adhesive layer with or without barrier. The output film 22 of station 1 becomes Ps2 for Station 2 and another substrate Ss2 from unwinder 28 is fed to Station 2. Lamination process layer 32 comprising of n sublayers act as adhesive layer with or without barrier, however any one Lamination process layer 20 or 32 has to be with barrier.

FIG. 2—A primary substrate (Ps-1) is provided from Roll 14 or Roll 8 depending on which side of the substrate coating is required. Coating process layer 20 comprising of n sublayers with or without barrier is layered on the substrate. The output film 22 of station 1 becomes Ps2 for Station 2 and another substrate Ss2 from unwinder 28 is fed to Station 2. Lamination process layer 32 comprising of n sublayers act as adhesive layer with or without barrier, however any one of the Coating process layer 20 or Lamination process layer 32 has to be with barrier.

FIG. 3—A roll 14 provides primary substrate 1 (Ps-1) 16 and roll 8 provide secondary substrate 1 (Ss1) 9 in. Lamination process layer 20 comprising of n sublayers act as adhesive layer with or without barrier. The output film 22 of station 1 becomes Ps2 for Station 2 and Coating process layer 32 comprising of n sublayers with our without barrier is layered on the substrate, however any one of the Coating process layer 32 or Lamination process layer 20 has to be with barrier. In this process roll 28 is in off condition or idle.

FIG. 4—A Substrate 9 is provided from Roll 8 and Coating process layer 20 comprising of n sublayers with our without barrier is layered on the substrate. The output film 22 of station 1 becomes Ps2 for station 2 and Coating process layer 32 comprising of n sublayers with our without barrier is layered on output film 22, however any one of the Coating process layer 20 or 32 has to be with barrier. In this process roll 28 is in off condition or idle.

FIG. 5—A roll 14 provides primary substrate 1 (Ps-1) 16 and roll 8 provide secondary substrate 1 (Ss1) 9. Lamination process layer 20 comprising of n sublayers act as adhesive layer with barrier. The output film 22 of station 1 becomes final laminate structure 12 and is wound on Roll 36. In this process Station 2 and roll 28 are in off condition or idle.

FIG. 6—A primary substrate (Ps-1) 16 is provided from Roll 14 or Roll 8 depending on which side of the substrate coating is required. Coating process layer 20 comprising of n sublayers with seal sublayer and barrier sublayers sandwiched and layered on the substrate. The output film 22 of station 1 becomes final laminate structure 12 and is wound on Roll 36. In this process Station 2, roll 8 and 28 are in off condition.

The laminate structure so produced offers better barrier in terms of Oxygen & Moisture and other gases and also retains the freshness and aroma of the product.

Extrusion coating being multilayered each sub layers can be varied in terms of polymer type and the thickness depending upon the level of barrier properties, in terms of oxygen & moisture and gases protection required by each product, which can be provided in a cost effective manner.

This invention can impart higher shelf life with cost effective laminate structure compared to prevailing systems/laminates available

Further, the present invention discloses a well-defined extrusion coating/lamination and the layers are tie/nylon/EVOH/nylon/tie that generates a uniform barrier in accordance with embodiments of the present invention.

The laminated structures may comprise of primary substrates (Ps1) and secondary substrates (Ss1) and/or secondary substrate (Ss2) on Extrusion coating/lamination Station, such that, the substrates Ps1, Ss1 and Ss2 are any type of films whether or not metallized or pearlised, matt or gloss, transparent or opaque, Cast or blown, mono or bi axially oriented, of PET, PP, PE/PA/EVOH/PS/PVC/PLA or blends thereof, comprising of one or more layers, Aluminum Foil, paper or laminate structure of any one or combinations of said substrates to form a laminated/coated roll by ECL or adhesive lamination (dry or wet lamination) by gravure process or mayer bar or transfer roll mechanism or any other such process.

Few of these combination of primary and secondary laminated substrates may be as following but not limited to following structure types, with reference to FIG. 1 to FIG. 6:

Structure Type 1—(FIG. 1)
A primary substrate (Ps1) and a secondary substrate (Ss1) on station 1
A multilayered Extrusion Coating layer, with or without barrier properties, acting as adhesion layer for Ps1 and Ss1
The laminate from station one acts as primary substrate (Ps2) on station 2 and another secondary layer (Ss2) wherein Ss2 is Sealant layer.
A multilayered Extrusion Coating layer, with barrier properties, acting as adhesion layer for Ps2 and Ss2.
For example:
Used for packing Ketchup pack or Meat packaging or Vacuum pack and the like.

Structure Type 2—(FIG. 2)
A primary substrate (Ps1)
A multilayered Extrusion Coating layer, with or without barrier properties,
The coated film from station one acts as primary substrate (Ps2) on station 2 and another secondary layer (Ss2) wherein Ss2 is Sealant layer.
A multilayered Extrusion Coating layer, with barrier properties, acting as adhesion layer for Ps2 and Ss2.

Structure Type 3—(FIG. 3)
A primary substrate (Ps1) and a secondary substrate (Ss1) on station 1
A multilayered extrusion lamination layer, with or without Barrier properties, acting as adhesion layer for Ps1 and Ss1.
The laminate from station one acts as primary substrate (Ps2) on station 2
A multilayered Extrusion Coating layer, with barrier properties, acting as adhesion layer and/or sealant layer or a release layer for Ps2.
For example:
Used for packing condoms and the like

Structure Type 4—(FIG. 4)
A primary substrate (Ps1)
A multilayered Extrusion Coating layer, with or without barrier properties on station 1
The film from station one acts as primary substrate (Ps2) on station 2
A multilayered Extrusion Coating layer, with barrier properties, acting as adhesion layer and/or sealant layer or a release layer for Ps2 on Station 2.

Structure Type 5—(FIG. 5)
A primary substrate (Ps1) and a secondary substrate (Ss1) on station 1
A multilayered Extrusion Lamination layer, with barrier properties, acting as adhesion layer for Ps1 and Ss1. Here Ss1 also acts as sealant layer.
For example:
Used for packing oils and lubricants and the like

Structure Type 6—(FIG. 6)
A primary substrate (Ps1)
A multilayered Extrusion Coating layer, with barrier properties, acting as adhesion layer for Ps1 also acts as sealant layer.
For example:
Used for packing Snack food, PET or BOPP having ECL with sealant layer and the like

The said laminates can be used for any type of packs like centre sealed pouches, three side sealed pouches, doy packs; with or without spouts, whether or not Nitrogen flushed or vacuum packed or any other type of flexible packaging

We claim:

1. Laminate structure for flexible packaging comprising high barrier properties to protect contents of packed material.

2. Laminate structure for flexible packaging as claimed in claim 1, wherein high barrier properties are obtained from the intermediate layers of multilayered extrusion coating/lamination.

3. Laminate structure for flexible packaging as claimed in claim 1, wherein it comprises primary substrate and/or secondary substrate.

4. Laminate structure for flexible packaging as claimed in claim 1, wherein process for preparation of laminate comprises two or more extrusion coating/lamination stations in one system.

5. Laminate structure for flexible packaging as claimed in claim 1, wherein, barrier layer(s) sandwiched by adhesive/tie layer(s) and/or further sandwiched between primary and secondary substrate at coating/laminating station.

6. Laminate structure for flexible packaging as claimed in claim 1, wherein the barrier material comprises single or combination of Nylon, EVOH, PVOH, PVDC, PGA, EAA, EMAA, EVA, IONOMERS, PC, PETG, PE, PP, Grafted polyolefins or TiO2.

7. Laminate structure for flexible packaging as claimed in claim 3, wherein primary or secondary substrate comprises surface or reverse printed or unprinted, coated or uncoated, mono or coextruded, cast or blown film of Pet/PP/PE/PA/EVOH/PS/PVC/PLA or blends there of mono or bi-axially oriented matt or gloss, opaque, transparent or pearlised whether or not metallized or paper or Aluminum, foil or laminate thereof by way of extrusion coating or solution based adhesive.

8. Laminate structure for flexible packaging as claimed in claims 3 and 5, wherein a laminate coming from previous station becomes primary substrate for the next station.

9. A process of preparation of laminate structure for flexible packaging with barrier properties comprises multilayer extrusion coating/lamination in single system with reduced number of layers.

10. A process of preparation of laminate structure for flexible packaging as claimed in claim 9, wherein multilayer comprises at least one primary substrate, barrier layer(s) and/or a secondary substrate.

11. A process of preparation of laminate structure for flexible packaging as claimed in claim 9 wherein, barrier with one or more material and adhesive material coming from same coating/lamination station.

12. A process of preparation of laminate structure for flexible packaging as claimed in claim 11 wherein, barrier layer(s) is sandwiched by adhesive/tie layer(s) which is further sandwiched between primary and secondary substrate at same coating/lamination station.

13. A process of preparation of laminate structure for flexible packaging as claimed in claim 9 wherein, the system comprises more than one coating/lamination station as per requirement.

14. A process of preparation of laminate structure for flexible packaging as claimed in claims 9 and 13 wherein, a laminate coming from previous station becomes primary substrate for the next station.

15. A process of preparation of laminate structure for flexible packaging as claimed in claim 9 wherein, barrier material comprises Nylon, EVOH, PVOH, PVDC, PGA, EAA, EMAA, EVA, IONOMERS, PC, PETG, PE, PP, Grafted polyolefins or TiO2.

16. A process of preparation of laminate structure for flexible packaging as claimed in claim 10 wherein, primary or secondary substrate comprises surface or reverse printed or unprinted, coated or uncoated mono or coextruded, cast or blown film of Pet/PP/PE/PA/EVOH/PS/PVC/PLA or blends there of mono or bi-axially oriented, matt or gloss, opaque, transparent or pearlised whether or not metallized or paper or Aluminum foil or laminate thereof by way of extrusion coating or solution based adhesive.

17. A process of preparation of laminate structure for flexible packaging comprises (FIG. 1):
A primary substrate (Ps1) and a secondary substrate (Ss1) on station 1
A multilayered Extrusion Coating layer, with or without barrier properties, acting as adhesion layer for Ps1 and Ss1
The laminate from station one acts as primary substrate (Ps2) on station 2 and another secondary layer (Ss2) wherein Ss2 is Sealant layer.
A multilayered Extrusion Coating layer, with barrier properties, acting as adhesion layer for Ps2 and Ss2.

18. A process of preparation of laminate structure for flexible packaging comprises (FIG. 2):
A primary substrate (Ps1)
A multilayered Extrusion Coating layer, with or without barrier properties,
The film from station one acts as primary substrate (Ps2) on station 2 and another secondary layer (Ss2) wherein Ss2 is Sealant layer.
A multilayered Extrusion Coating layer, with barrier properties, acting as adhesion layer Ps2 and Ss2.

19. A process of preparation of laminate structure for flexible packaging comprises (FIG. 3):
A primary substrate (Ps1) and a secondary substrate (Ss1) on station 1
A multilayered extrusion lamination layer, with or without Barrier properties, acting as adhesion layer for Ps1 and Ss1.
The laminate from station one acts as primary substrate (Ps2) on station 2
A multilayered Extrusion Coating layer, with barrier properties, acting as adhesion layer and/or sealant layer or a release layer for Ps2.

20. A process of preparation of laminate structure for flexible packaging comprises (FIG. 4):
A primary substrate (Ps1)
A multilayered Extrusion Coating layer, with or without barrier properties on station 1
The film from station one acts as primary substrate (Ps2) on station 2
A multilayered Extrusion Coating layer, with barrier properties, acting as adhesion layer and/or sealant layer or a release layer for Ps2 on Station 2.

21. A process of preparation of laminate structure for flexible packaging comprises (FIG. 5):
A primary substrate (Ps1) and a secondary substrate (Ss1) on station 1
A multilayered Extrusion Lamination layer, with barrier properties, acting as adhesion layer for Ps1 and Ss1. Here Ss1 also acts as sealant layer.

22. A process of preparation of laminate structure for flexible packaging comprises (FIG. 6):
A primary substrate (Ps1)
A multilayered Extrusion Coating layer, with barrier properties, acting as adhesion layer for Ps1 also acts as sealant layer.
